(19) United States
(12) Patent Application Publication
(10) Pub. No.: US 2016/0293332 A1
(43) Pub. Date: Oct. 6, 2016

(54) MULTILAYER CERAMIC CAPACITOR

(71) Applicant: TAIYO YUDEN CO., LTD., Tokyo (JP)

(72) Inventors: Yoichi KATO, Takasaki-shi (JP); Kotaro MIZUNO, Takasaki-shi (JP); Yukihiro KONISHI, Takasaki-shi (JP); Yoshinori TANAKA, Takasaki-shi (JP); Yusuke KOWASE, Takasaki-shi (JP); Shohei KITAMURA, Takasaki-shi (JP); Toru MAKINO, Takasaki-shi (JP)

(21) Appl. No.: 15/072,155

(22) Filed: Mar. 16, 2016

(30) Foreign Application Priority Data
Mar. 30, 2015 (JP) 2015-069462
Dec. 22, 2015 (JP) 2015-250225
Jan. 8, 2016 (JP) 2016-002749

(51) Int. Cl. H01G 4/30; H01G 4/248; H01G 4/12; H01G 4/012

(52) U.S. Cl. CPC H01G 4/30; H01G 4/012; H01G 4/248; H01G 4/12

(57) ABSTRACT

A multilayer ceramic capacitor includes an element body which is constituted by dielectric layers stacked alternately with internal electrode layers having different polarities and whose shape is roughly a rectangular solid having a pair of principle faces, a pair of end faces, and a pair of side faces, wherein the multilayer ceramic capacitor is such that the pair of side faces of the element body has a pair of side margins whose thickness is 30 μm or less, and external electrodes are formed on the pair of end faces, and at least one of the pair of principle faces, of the element body. Despite the multilayer ceramic capacitor whose side margins are as thin as 30 μm or less, leak current can be suppressed.

### BACKGROUND

1. Field of the Invention

The present invention relates to a multilayer ceramic capacitor which has thin side margins, yet whose leak current between the external electrode and internal electrode is suppressed.

2. Description of the Related Art

A multilayer ceramic capacitor (MLCC) generally has a laminate constituted by dielectric layers stacked alternately with internal electrode layers having different polarities, wherein the structure is such that external electrodes are formed on the pair of faces of the laminate to which the internal electrode layers are led out alternately. And, in FIG. 7 showing a rough perspective view of a representative multilayer ceramic capacitor 100, generally the faces on which the internal electrode layers are led out to left and right external electrodes 104 are called “end faces” 102a, b, the top and bottom faces in the direction of lamination of the internal electrode layers and dielectric layers are called “principle faces” 102c, d, and the remaining pair of faces are called “side faces” 102e, f.

In addition, generally a pair of side margins constituting the pair of side faces are provided for the purposes of, for example, preventing the internal electrode layers from being exposed to the outside and getting broken or damaged.

Patent Literature 1 studies securing the maximum effective area to secure enough volume for internal electrode patterns. The literature describes that, when an effective area was secured accordingly, the margins became thin and problems of shorted or short-circuited internal electrode patterns occurred.

To solve such problems, the literature proposes forming a laminate of dielectric layers and internal electrode patterns and then using a specified ceramic slurry to form side margins. It is described that, this way, the side margin would become thinner and an effective area would be secured, while the aforementioned shorting or short-circuiting would also be prevented.

Incidentally, in recent years, the high demand for smaller electronic components to support higher-density electronic circuits used in mobile phones, tablet terminals, and other digital electronic devices is accelerating the development of smaller, larger-capacitance multilayer ceramic capacitors which constitute these circuits.

The capacitance of a multilayer ceramic capacitor is directly proportional to the dielectric constant of the material constituting the dielectric layers that in turn constitute the capacitor, the number of dielectric layers to be stacked, and the effective internal electrode layer area or specifically the area of the overlapping parts of the internal electrode layers led out to the external electrodes alternately, and is inversely proportional to the thickness of one dielectric layer.

### BACKGROUND ART LITERATURES

[Patent Literature 1] Japanese Patent Laid-open No. 2012-195555

### SUMMARY

(When a multilayer ceramic capacitor has thicker side margins, the area of internal electrode layers decreases accordingly and consequently the effective area decreases and so does the capacitance of the capacitor.

Accordingly, the inventors of the present invention studied forming thin side margins and found that, while making them as thin as 30 μm or less was possible, doing so would create a new problem which is that, due to thin side margins, leak current would increase between the wraparound part of the external electrode and the internal electrode layer located in close proximity thereto.

This point is explained in greater detail by referring to FIG. 8. FIG. 8 is a schematic view of a cross section of a multilayer ceramic capacitor 100, cut in such position that an internal electrode layer 106 running in parallel with the principle faces 102c, d is visible. The multilayer ceramic capacitor 100 has a pair of external electrodes 104 on its two end faces for connection to a board, etc., but these external electrodes 104 generally wrap around four other faces in addition to the two end faces (so-called five-face electrodes) to allow for connection with a board, etc., on any of the faces. Then, in FIG. 8, the internal electrode layer 106 connects to the right external electrode 104, but it is not connected to the left external electrode 104 and maintains a specific distance and is thus insulated from the left external electrode. However, it was revealed that, when a side margin 108 is as thin as 30 μm or less, the thickness of the side margin 108 would become smaller than the aforementioned distance and therefore leak current would generate between the interface of the internal electrode layer 106 and side margin 108 on one hand, and the part of the external electrode 104 wrapping around the side face on the other, at the edge of the internal electrode layer 106 closer to the left external electrode 104.

Accordingly, an object of the present invention is to suppress leak current in a multilayer ceramic capacitor whose side margins are as thin as 30 μm or less.

Any discussion of problems and solutions involved in the related art has been included in this disclosure solely for the purposes of providing a context for the present invention, and should not be taken as an admission that any or all of the discussion were known at the time the invention was made.

The inventors of the present invention studied in earnest to achieve the aforementioned object and found that the problem of leak current mentioned above could be resolved by a constitution wherein the external electrode does not wrap around the side margin even when it is as thin as 30 μm or less, and thus completed the present invention.

In other words, the present invention is a multilayer ceramic capacitor having an element body which is constituted by dielectric layers stacked alternately with internal electrode layers having different polarities and whose shape is roughly a rectangular solid having a pair of principle faces, a pair of end faces, and a pair of side faces, wherein the multilayer ceramic capacitor is such that the pair of side faces of the element body has a pair of side margins whose thickness is 30 μm or less, and external electrodes are formed on the pair of end faces, and at least one of the pair of principle faces, of the element body.

From the viewpoint of improving the productivity of multilayer ceramic capacitor, preferably the thickness of the pair of side margins is 1 μm or more.

A constitution wherein the external electrodes are formed on the pair of end faces and one principle face of the element body is preferable from the viewpoint of increasing the capacitance of the multilayer ceramic capacitor, because the absence of an external electrode on the other principle face means that the number of internal electrode layers to be stacked can be increased.

And, also from the same viewpoint of increasing the capacitance of the multilayer ceramic capacitor, preferably the thickness of the dielectric layer is reduced to as thin as 0.8 μm or less so as to increase the number of internal electrode layers to be stacked.

According to the present invention, a multilayer ceramic capacitor whose side margins are as thin as 30 μm or less and which suppresses leak current and offers excellent reliability can be provided.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 shows a rough perspective view of a multilayer ceramic capacitor conforming to the present invention.

FIG. 2 shows a schematic view of a cross section of the multilayer ceramic capacitor 10 conforming to the present invention, cut in parallel with its side faces 12e, f

FIG. 3A, FIG. 3B, and FIG. 3C are concept drawings used for obtaining the thickness of the side margin 24.

FIG. 4 shows a schematic view of a cross section of the multilayer ceramic capacitor 10, cut in such position that the internal electrode layer 18 running in parallel with the principle faces 12c, d is visible.

FIG. 5A, FIG. 5B, and FIG. 5C show schematic views showing one example of how side margins are formed.

FIG. 6 shows a schematic view showing one example of how side margins are formed.

FIG. 7 shows a rough perspective view of a representative ceramic capacitor.

FIG. 8 shows a schematic view of a cross section of the multilayer ceramic capacitor 100, cut in such position that the internal electrode layer 106 running in parallel with the principle faces 102c, d is visible.

### DESCRIPTION OF THE SYMBOLS

10 Multilayer ceramic capacitor

12a, b End face

12c, d Principle face

12e, f Side face

14 External electrode

16 Element body

17 Dielectric layer

18 Internal electrode layer

20 Laminate

22 Cover layer

24 Side margin

26a, b, c Cross section

30 Position corresponding to the end of the internal electrode layer

32 Normal line of principle face d

100 Multilayer ceramic capacitor

102a, b End face

102c, d Principle face

102e, f Side face

104 External electrode

106 Internal electrode layer

108 Side margin

200 Internal electrode pattern

202 Bar-like laminate

204 Side margin

206 Laminate chip

300 Laminate chip

302 Group stage

304a to d Block material

306 Squeegee

### DETAILED DESCRIPTION OF EMBODIMENTS

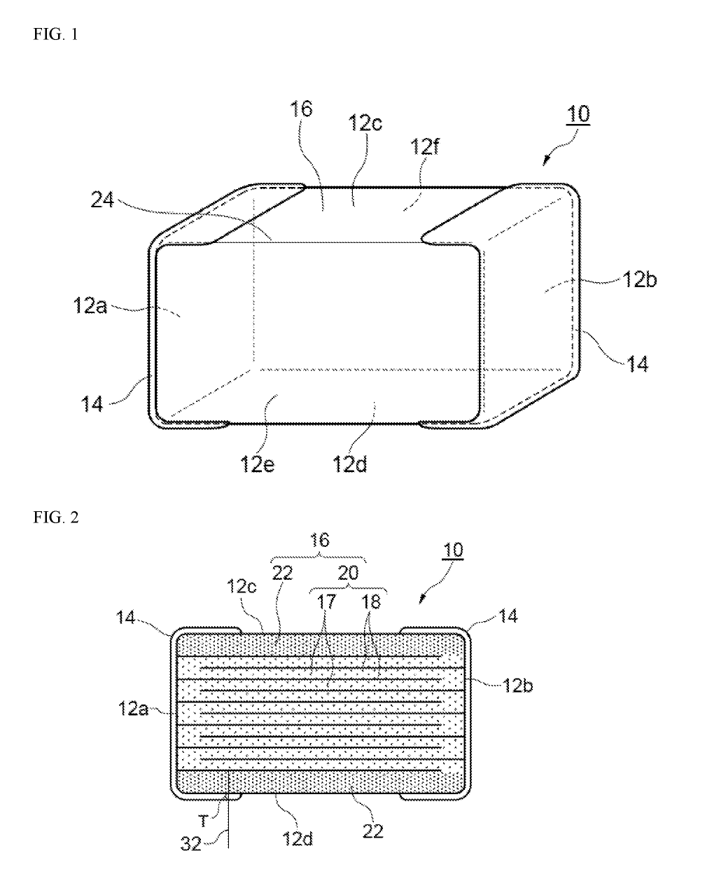

The multilayer ceramic capacitor in an embodiment of the present invention is explained below. FIG. 1 is a rough perspective view of a multilayer ceramic capacitor 10 conforming to the present invention. Also under the present invention, the faces on which the internal electrode layers are led out to left and right external electrodes 14 are called “end faces” 12a, b, the top and bottom faces in the direction of lamination of the internal electrode layers and dielectric layers are called “principle faces” 12c, d, and the remaining pair of faces are called “side faces” 12e, f, as under the prior art.

[Multilayer Ceramic Capacitor]

FIG. 2 shows a schematic view of a cross section of the multilayer ceramic capacitor 10 conforming to the present invention, cut in parallel with its side faces 12e, f. The multilayer ceramic capacitor 10 is generally constituted by an element body 16 having standardized chip dimensions and shape (such as rectangular solid of 1.0×0.5×0.5 mm), as well as a pair of external electrodes 14 primarily formed on both end face sides of the element body 16. The element body 16 has a laminate 20 made of grain crystal such as BaTiO₃, CaTiO₃, SrTiO₃, and CaZrO₃ as its primary constituent, and is internally constituted by dielectric layers 17 stacked alternately with internal electrode layers 18, while also having cover layers 22 formed at the top and bottom in the direction of lamination as outermost layers. Although not illustrated, side margins 24 forming a pair of side faces 12e, f are present in such a way that they cover the laminate 20 (internal electrode layers 18 thereof) and thereby prevent it from being exposed to the outside (refer to FIG. 1).

The laminate 20 is such that the thickness of the internal electrode layer 18 and that of the dielectric layer 17 sandwiched by two internal electrode layers 18 are set within specified ranges according to the static capacitance, required withstand voltage, and other specifications, and said laminate has a high-density multi-layer structure consisting of a total of around several hundred to a thousand layers.

The cover layers 22 and side margins 24 formed around the laminate 20 protect the dielectric layers 17 and internal electrode layers 18 against moisture, contaminants, and other polluting substances from the outside, and prevent them from deteriorating over time.

Also, the internal electrode layers 18 are alternately led out to and electrically connected at their edges with a pair of external electrodes 14 that are present on both ends of the dielectric layers 17 in the length direction and that each have a different polarity.

Then, with the multilayer ceramic capacitor 10 conforming to the present invention, the thickness of the side margin 24 is extremely thin, or 30 μm or less to be specific. Preferably the side margins 24 have a thickness of 1 μm or more from the viewpoints that, if they are too thin, production may become extremely difficult and the internal electrode layers 18 may be soiled or damaged from the outside. Under the present invention, the thickness of the side margin 24 is obtained as described below.

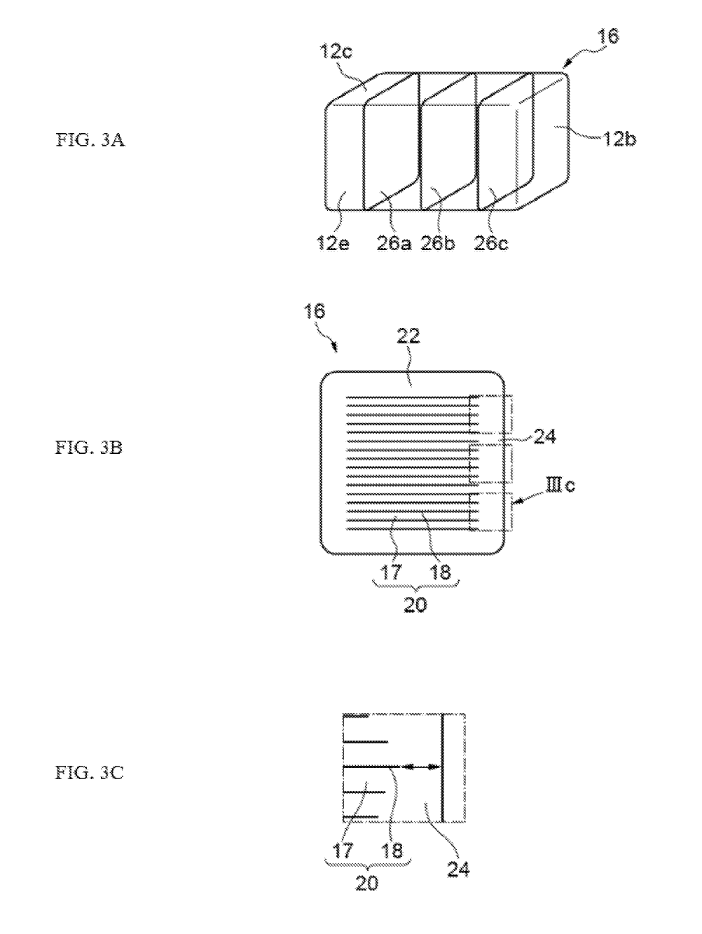

FIGS. 3A, 3B, and 3C are concept drawings used for obtaining the thickness of the side margin 24. As shown in FIG. 3A, the element body 16 is cut at the center, right side, and left side of the principle face 12c of the element body 16 to create three cross sections 26a, b, c running in parallel with the end faces 12a, b (the cross sections 26a and 26c are such that the ratio of their distance to the closer end face and distance to the center is 2:3, and the cross section 26b is located at the center; FIG. 3B is a schematic drawing showing these cross sections), and they are observed using a SEM at magnifications of 3000 times. They are observed in three view fields including, as shown in FIG. 3B, the top part (the center of the view field is near a point 100 μm downward of the top edge (the top right-hand corner of the frame shape formed by the top and bottom cover layers 22 and left and right side margins 24 in FIG. 3B) of the top cover layer 22), center part (the center of the view field is the midpoint of the top end face and bottom end face of the top and bottom cover layers 22), and bottom part (the center of the view field is near a point 100 μm upward of the bottom edge (the bottom right-hand corner of the aforementioned frame shape) of the bottom cover layer 22) of the side margin 24 in the obtained cross sections 26a, b, c, and both the left and right side margins 24 are observed. In other words, 3(view fields)×2(both sides)×3(cross sections)=18 view fields are observed per one element body 16. FIG. 3C shows an enlarged view (schematic view of SEM-observed image) of the view field denoted by symbol IIIc in FIG. 3B.

Of the lengths from the ends of the internal electrode layers 18 contacting the side margin 24 to the interface of the element body 16 and outside beyond the side margin 24 as observed in each of these view fields, the shortest distance (the interface of the side margin 24 and laminate 20 may not be straight, as shown in the schematic view of FIG. 3C) is defined as the effective cover thickness in each view field (the length indicated by the double arrow), and the effective cover thickness is obtained for each of the 18 view fields of the element body 16. This is done for three element bodies 16 and the average of the effective cover thicknesses in a total of 54 view fields is taken as the thickness of the side margin 24 of the multilayer ceramic capacitor 10 manufactured under each set of conditions. In embodiments, the shortest distance refers to a shortest distance between the side face and the internal electrode layers wherein a distance between each internal electrode layer and the side face may vary due to ordinary manufacturing variance, rather than intentional change in dimension.

With the multilayer ceramic capacitor 10 conforming to the present invention, the thickness of the side margin 24 as defined above is extremely thin, or 30 μm to be specific, and therefore the effective area of internal electrode layers 18 can be increased accordingly so that the capacitor has larger capacitance.

However, making the side margins this thin causes leak current to generate between the interface of the internal electrode layer and side margin on one hand, and the part of the external electrode wrapping around the side face on the other, at the end near the external electrode on the opposite side of the one to which the internal electrode layer is led out, as explained in [Problems to Be Solved by the Invention] above.

To solve such problem, therefore, under the present invention the external electrodes 14 are formed on the pair of end faces 12a, b, and at least one of the pair of principle faces 12c, d, of the element body 16 to provide L-shaped two-face electrodes or U-shaped three-face electrodes. The constitution wherein the external electrodes 14 are formed this way and substantially not formed on the pair of side faces 12e, f prevents the aforementioned problem of leak current.

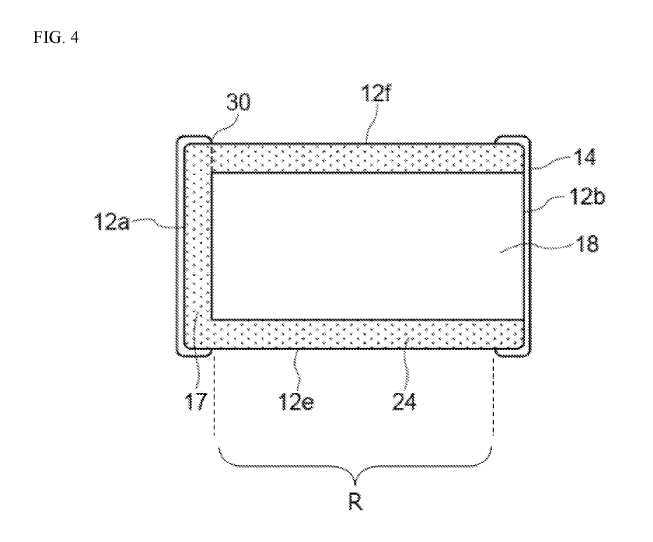

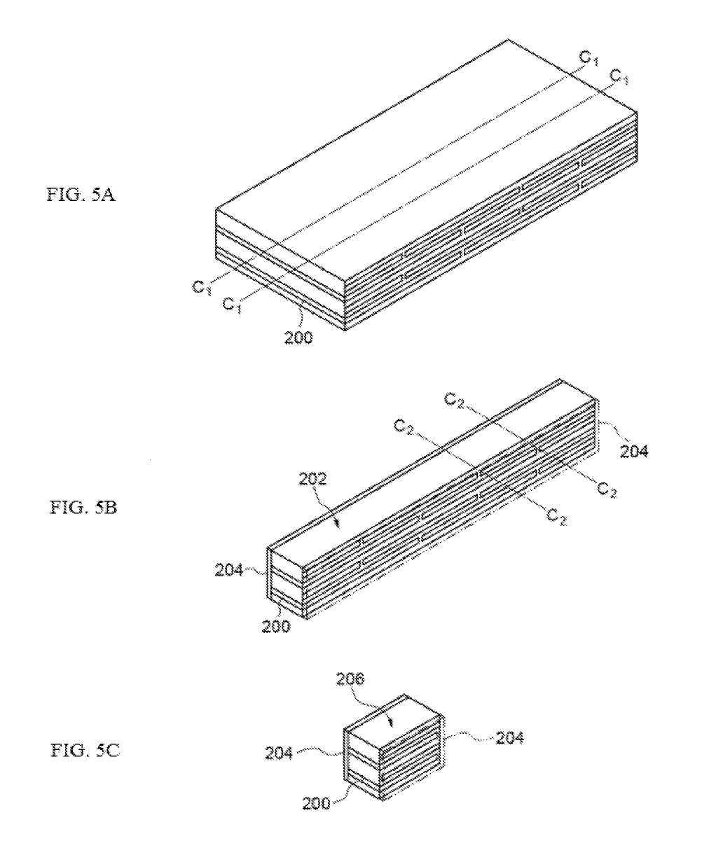

Note that “substantially not formed on the pair of side faces 12e, f” includes not only where external electrodes 14 are not present at all on the entire side faces 12e, f, but also where the external electrodes 14 extend partially or slightly to the side faces. To be specific, in FIG. 4 which is a schematic view of a cross section of the multilayer ceramic capacitor 10, cut in such position that the internal electrode layer 18 running in parallel with the principle faces 12c, d is visible, an external electrode 14 may be formed on the side face 12f from the point of intersection between the side face 12f and end face 12a to a position 30 corresponding to the end, on the end face 12a side, of the internal electrode layer 18 led to the end face 12b side, for example. This is because leak current does not generate if this range is maintained. The same applies to the end face 12b and side face 12e on the opposite side. That is, no external electrodes are formed in a region R of the pair of side faces 12e, 12f where the internal electrode layers 18 having different polarities overlap as viewed in a thickness direction.

Also under the present invention, where the external electrodes 14 are formed on at least one of the pair of principle faces 12c, d, external electrodes 14 may not be formed on one principle face 12c, for example. Here, “external electrodes 14 may not be formed on one principle face 12c” includes not only where external electrodes 14 are not present at all on the principle face 12c, but also where an external electrode 14 is formed on the cover layer 22 from the point of intersection between the principle face 12c and end face 12a to the position corresponding to the end, on the end face 12a side, of the internal electrode layer 18 led to the end face 12b side, for example, as is the case with the side faces 12e, f. The same applies to the end face 12b on the opposite side.

Under the present invention, preferably the external electrodes 14 are formed on one of the pair of principle faces 12c, d. This is because the absence of external electrode on the other principle face means that the number of internal electrode layers 18 to be stacked can be increased, which in turn allows for increase in the capacitance of the multilayer ceramic capacitor 10. On the principle face where the external electrodes 14 are formed, the external electrodes 14 do not cover the entire principle face, but they are instead formed on the end face 12a side and end face 12b side separated with a certain distance.

Preferably the thickness of the dielectric layer 17 is 0.8 μm or less from the viewpoint of increasing the capacitance of the multilayer ceramic capacitor 10. This is because making the dielectric layer 17 thinner increases the capacitance and also the thinner dielectric layer 17 means that the number of internal electrode layers 18 to be stacked can be increased.

Also, preferably the thickness of the external electrode 14 formed on one principle face 12d is 1 to 30 μm from the viewpoint of increasing the number of internal electrode layers 18 to be stacked and thereby increasing the capacitance of the multilayer ceramic capacitor 10. The thickness of the external electrode 14 is the maximum value of the length T from the point of intersection with the principle face 12d to the end of the external electrode 14 along a normal line 32 (there are multiple normal lines) of the principle face 12d passing the external electrode 14 in FIG. 2. FIG. 2 does not show a clear starting point of the principle face 12d, but in such a case the principle face 12d is considered to start from where the curved part of the end face 12a ends.

In addition, with the multilayer ceramic capacitor 10 conforming to the present invention, the thickness of the cover layer 22 and that of the internal electrode layer 18 are not limited in any way; however, the thickness of the cover layer 22 is normally 5 to 40 μm, while the thickness of the internal electrode layer 18 is normally 0.2 to 1.0 μm.

[Manufacturing Method of Multilayer Ceramic Capacitor]

Next, the manufacturing method of the multilayer ceramic capacitor conforming to the present invention as described above is explained.

First, material powder for forming the dielectric layer is prepared. For the material powder, BaTiO₃, CaTiO₃, SrTiO₃, CaZrO₃, and various other powders that can be used to form ceramic sintered compact can be used.

These powders can be synthesized by causing various metal materials to react together. Various synthesizing methods are known, such as the solid phase method, sol-gel method, and hydrothermal method, among others. Under the present invention, any of these methods can be adopted.

To the obtained material powder, compounds that constitute secondary constituents can be added by specified amounts according to the purposes. Secondary constituents include oxides of rare earths such as Nd, Sm, Eu, Gd, Tb, Dy, Ho, and Er, as well as oxides of Mg, Mn, Ni, Co, Fe, Cr, Cu, Al, Mo, W, V, and Si.

The material powder obtained as above can be pulverized to adjust the grain size, or pulverized and then classified to regulate the grain size, as necessary, for example.

Then, binder such as polyvinyl butyral (PVB) resin, organic solvent such as ethanol or toluene, and plasticizer such as dioctyl phthalate (DOP) are added to the material powder and the ingredients are wet-mixed. The obtained slurry is applied on a base material in strips using the die-coater method or doctor blade method, for example, after which the slurry is dried to obtain a dielectric green sheet of 1.2 μm or less in thickness. Then, on the surface of the obtained dielectric green sheet, a metal conductive paste containing organic binder is printed by means of screen printing or gravure printing to arrange patterns of internal electrode layers to be led out alternately to the pair of external electrodes each having a different polarity. For the aforementioned metal, nickel is widely adopted from the viewpoint of cost.

Thereafter, the dielectric green sheet on which internal electrode layer patterns have been printed is stamped out to specified sizes and the stamped-out dielectric green sheets are stacked together by a specified number (such as 100 to 1,000 layers) so that when the base material is separated, the internal electrode layers and dielectric layers are staggered and also the edges of the internal electrode layers are exposed on both end faces of the dielectric layers in the length direction and led out alternately to the pair of external electrodes each having a different polarity. Cover sheets that will become the cover layers are pressure-bonded on top and bottom of the stacked dielectric green sheets and the bonded sheets/covers are cut to specified chip dimensions (such as 1.2 mm×0.7 mm×0.7 mm in size after sintering).

Here, any of various known methods for forming side margins can be adopted without any limitation, so long as side margins of the thickness specified under the present invention can be formed. In the aforementioned cutting to specified chip dimensions, for example, the cutting positions are set to not align exactly with the outlines of the internal electrode layers, but they are instead set slightly wider to include the parts of the dielectric layers not covered by the internal electrode layers, and accordingly side margins of 30 μm or less in thickness are formed on both side faces of the laminate, in order to obtain an element body precursor that will become an element body 16 when sintered.

According to such method, the multiple printed internal electrode layers exist in the element body precursor in the as-printed shape, where it may be difficult to make the internal electrode layers have a completely identical printed shape, and it is also difficult, when stacking the dielectric green sheets on which the internal electrode layers have been printed, to stack the multiple staggered internal electrode layers in a manner allowing them to overlap completely and they may be stacked with a slight offset instead. For this reason, the interface of the laminate 20 constituted by multiple internal electrode layers 18 and dielectric layers 17 and the side margin 24 may not be straight within the element body precursor, as shown in FIG. 3C, and in this case the side margin 24 becomes very thin in some areas and it is considered that the internal electrode layers 18 become more susceptible to soiling and damage from the outside in these areas.

To prevent such situation, the present invention allows side margins to be formed in the manner described below. To be specific, as shown in FIG. 5A, multiple dielectric green sheets on which internal electrode patterns 200 have been printed in stripes at a specified interval (this corresponds to twice the distance between the external electrode 14 and the edge of the internal electrode layer 18 led out to the external electrode 14 on the opposite side of the aforementioned external electrode 14 in FIG. 2) are stacked together in such a way that the center of a stripe overlaps with the interval part between internal electrode patterns 200.

Cut this along line C₁-C₁ so that the striped internal electrode patterns 200 are cut across, to obtain a bar-like laminate 202 not having a pair of opposing side margins 204 as shown in FIG. 5B. Here, the cutting width (distance between the cross sections produced by cutting) corresponds to the size of the multilayer ceramic capacitor to be manufactured, or specifically to the distance between the pair of side faces 12e, f of the element body 16.

Side margins 204 are formed on the side faces of the obtained bar-like laminate 202 in such a way that their thickness after sintering would become 30 μm or less (normally side margins are formed using a material similar to that of the dielectric layers 17), which is then cut along line C₂-C₂ into individual chip sizes (line C₂-C₂ passes through the center of the internal electrode pattern 200 or center of the interval between internal electrode patterns 200), to obtain individual laminate chips 206 (FIG. 5C). On this chip 206, the internal electrodes are led out alternately on the cross sections produced by the aforementioned cutting and this chip 206 represents an element body precursor that will become the element body 16 after sintering.

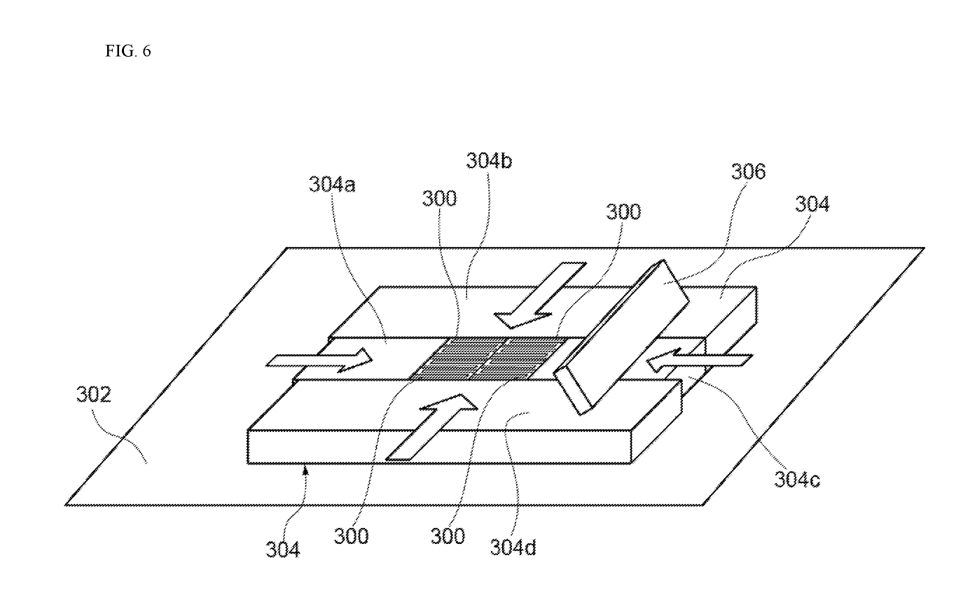

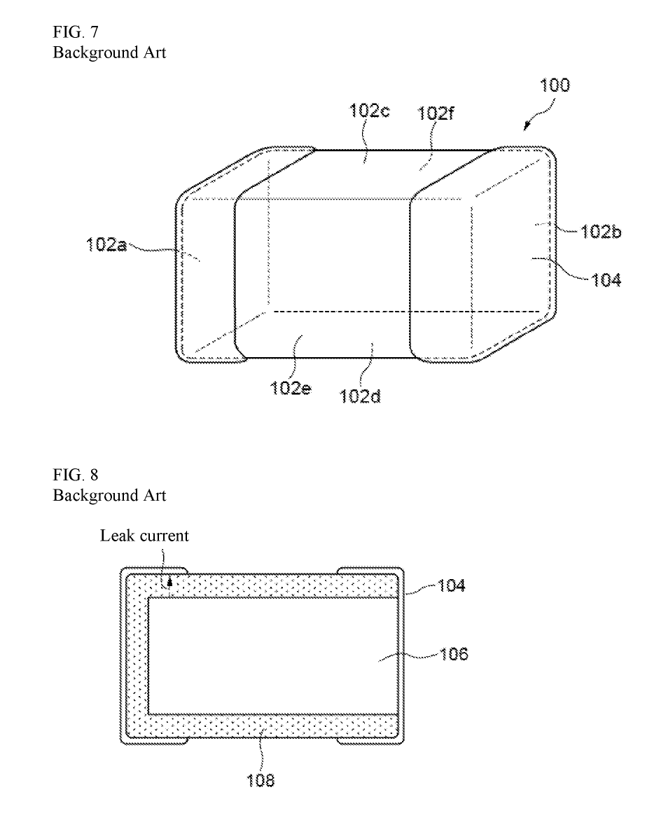

Also, a different method can be used to form side margins as follows. To be specific, as shown in FIG. 6, the laminate of dielectric green sheets is cut at exactly at the positions of the internal electrode layers or slightly inside, and obtained laminate chips 300 (the internal electrode layers are exposed on their side face) are arranged on a group stage 302 so that their side face faces up. Then, on the group stage 302, multiple block materials 304a to 304d that can slide in the directions of the arrows as shown in the figure are caused to slide on the group stage 302 in the directions of the arrows. This way, an aggregate of rectangular planar shape constituted by multiple laminate chips 300 adhering together is obtained.

Then, in this condition, a squeegee 306 is used to apply a ceramic paste (normally material similar to the one used to form the dielectric layers 17) to form a ceramic paste layer of specified thickness on the top face of the aggregate and then the paste is dried. This thickness can be adjusted by adjusting the difference between the height of the arranged laminate chips 300 and the height of the block materials 304.

Since the ceramic paste layer is formed over the entire surface of the aggregate of laminate chips 300, a roller may be run over the top face of the aggregate under pressure or a blade may be pressed against positions corresponding to the boundaries of the laminate chips 300, to divide the ceramic paste layer to cover individual laminate chips 300.

This way, a side margin of specified thickness is formed on one side face of the laminate chip 300, and by flipping the chip and repeating the same operation as described above, a side margin can be formed on the other side face in a similar manner and an element body precursor that will become the element body 16 after sintering can be obtained.

In addition, the corners of the element body precursor may be chamfered after the cover layers and side margins have been formed, to shape the element body precursor in such a way that the connection part of each side of the element body precursor is curved. This way, chipping of the corners of the element body precursor can be suppressed.

To achieve this shape, all that is needed is, for example, to put water, multiple element body precursors, and polishing medium into a sealed rotary pot made of polyethylene or other material and rotate this sealed rotary pot to chamfer the corners of the element body precursors.

The element body precursors obtained as above, constituted by the laminate of dielectric layers and internal electrode layers, cover layers covering the top and bottom principle faces of the laminate, and side margins covering both side faces of the laminate, are put in an N₂ ambience of 250 to 500° C. to remove the binder, and then sintered for 10 minutes to 2 hours in a reducing ambience of 1100 to 1300° C., to sinter and densify each compound constituting the aforementioned dielectric green sheet. This way, the element body 16 of the multilayer ceramic capacitor 10 conforming to the present invention is obtained.

Under the present invention, re-oxidizing treatment can also be given at 600 to 1000° C.

Then, external electrodes 14 are formed on both end faces, and at least one of the pair of principle faces, of the obtained element body 16. To form external electrodes at such specific positions, the method below may be adopted, for example.

The element bodies 16 are arranged so that their principle face or side face contacts the bottom, and an external electrode paste constituted by Cu or other metal grains, ethyl cellulose or other organic binder, dispersant, and solvent is applied by means of printing to one principle face or both principle faces, and then dried, to form external electrodes on the principle face (external electrodes formed on both principle faces are U-shaped three-face electrodes, while those formed on one principle face are L-shaped two-face electrodes). Thereafter, similar paste is dip-coated onto both end faces of the element body 16 and then dried, followed by baking. Thereafter, Ni/Sn plating film is formed.

The formation of external electrodes 14 on the principle face can also be implemented by using, when forming the cover layer 22, cover sheets whose surfaces have been pre-printed with external electrode patterns.

Also, external electrodes 14 can be formed by means of sputtering or deposition on the principle face and end face.

This way, external electrodes 14 are formed on the pair of end faces, and at least one of the pair of principle faces, of the element body 16, and consequently a multilayer ceramic capacitor 10 conforming to the present invention is manufactured which has side margins of 30 μm or less in thickness on the pair of side faces.

### EXAMPLE

The present invention is explained in greater detail below using examples. It should be noted, however, that the present invention is not limited to these examples in any way.

[Manufacturing of Multilayer Ceramic Capacitor]

Dy and Mg were each added by 1.0 mol, and V and Mn were each added by 0.5 mol, per 100 mol of barium titanate of 0.1 μm in average grain size, into which organic solvent whose primary constituent is alcohol, polyvinyl butyral resin, dispersant and plasticizer were mixed and dispersed to produce a coating slurry. Then, this slurry was coated on a base material using a die-coater to produce a dielectric green sheet. The amount of slurry supplied to the die-coater was adjusted to control the thickness of sheet.

Next, the aforementioned dielectric green sheet was screen-printed with a conductive paste prepared by mixing and dispersing Ni powder of 200 nm in average grain size, organic solvent whose primary constituent is alcohol, ethyl cellulose resin, dispersant, and plasticizer, to produce a dielectric green sheet printed with internal electrodes. The concentration of solid matter in the conductive paste was adjusted by the amount of paste solvent, to control the thickness of the internal electrode.

Multiple layers of dielectric green sheets (for forming the cover layers) and multiple layers of dielectric green sheets printed with internal electrodes were stacked together and then pressure-bonded and cut to produce individual unsintered laminates.

The unsintered laminates were arranged so that their side margin faces (side face) faced up. Dy and Mg were each added by 1.0 mol, and V and Mn were each added by 0.5 mol, per 100 mol of barium titanate of 0.1 μm in average grain size, into which organic solvent whose primary constituent is alcohol, ethyl cellulose resin, dispersant, and plasticizer were mixed and dispersed to produce a ceramic paste. Then, this ceramic paste was applied to the top faces of the arranged unsintered laminates and then dried, to form side margins. The application thickness of the paste was changed to control the thickness of side margins. The opposing side margin faces were also treated in a similar manner, and element body precursors were obtained as a result.

Water, multiple element body precursors, and polishing medium were placed in a sealed rotary pot and this sealed rotary pot was rotated to chamfer the corners of the element body precursors.

The element body precursors thus obtained, each constituted by the laminate of dielectric layers and internal electrode layers, cover layers covering the top and bottom principle faces of the laminate, and side margins covering both side faces of the laminate, were put in an N₂ ambience of 250 to 500° C. to remove the binder, and then sintered for 10 minutes to 2 hours in a reducing ambience of 1100 to 1300° C.

The obtained element bodies were arranged so that their principle face or side face contacted the bottom, and an external electrode paste constituted by Cu grains, ethyl cellulose, dispersant, and solvent was applied to one principle face or both principle faces by means of printing, and then dried to form external electrodes on the principle face. Thereafter, both end faces of the element body were dip-coated with a similar paste and then dried and baked. Thereafter, Ni/Sn plating film was formed.

As for the comparative example based on five-face electrodes, the element bodies were arranged so that one of their end faces matched in height, and external electrode paste similar to the foregoing was dip-coated by soaking one end face, both principle faces, and both side faces partially, and then dried. An external electrode was also formed in a similar manner on the other end face, followed by baking. Thereafter, Ni/Sn plating film was formed.

Multilayer ceramic capacitors of the constitution shown below were manufactured as described above:

Chip dimensions (L×W×H) 1.0 mm×0.5 mm×0.5 mm

Thickness of dielectric layer 0.5 μm, 0.8 μm

Number of dielectric layers 300 layers

Thickness of internal electrode layer 0.7 μm

Number of internal electrode layers 301 layers

Thickness of cover layer 35 μm

Thickness of side margin 1.2 μm to 39.1 μm

Thickness of external electrode (including plating) 30 μm

Thickness of end margin 50 μm

*The thickness of end margin refers to the minimum value of the distance between the edge of the internal electrode layer on the side of the external electrode to which it is not led out, and this external electrode.

The thickness of the dielectric layer and that of the internal electrode layer were measured as follows. To be specific, the multilayer ceramic capacitor, from one end face to the other end face, was equally divided into four to prepare three cross sections in parallel with the end faces, and thickness was measured for 20 randomly-selected dielectric layers and 20 randomly-selected internal electrode layers in each of the cross sections, after which the results were averaged to obtain the representative thickness of the dielectric layer and that of the internal electrode layer.

[Measurement of Leak Current]

Each of the obtained multilayer ceramic capacitors in the examples and comparative example was measured for leak current.

Equipment: ADCMT-5451 digital ultra-high resistance/micro ammeter

Conditions: Room temperature (after 4 V has been applied for 60 seconds), Measurement sample size: 10 samples

Threshold: Lower than that of the five-face electrode type (multilayer ceramic capacitor in the comparative example)

Using the 5451 digital ultra-high resistance/micro ammeter manufactured by ADCMT, the multilayer ceramic capacitors in the examples and comparative example were measured for current flowing through the capacitor after applying DC voltage to the external electrodes on both ends. The measurement was conducted at room temperature, the applied voltage was set to 4 V, and measurement began 60 seconds after the start of application of voltage. Under these conditions, 10 samples were measured for each capacitor and their average was obtained. The results are shown in Tables 1 and 2 below.

TABLE 1
Thickness of dielectric layer: 0.8 μm
Current (nA)

| | Five-face | L-shaped | U-shaped |
|---|---|---|---|
| Thickness of | electrodes | two-face | three-face |
| side margin | (Comparative | electrodes | electrodes |
| (μm) | example) | (Example) | (Example) |
| 1.2 | 3151 | 237 | 231 |
| 5.3 | 1017 | 241 | 229 |
| 10.2 | 539 | 232 | 237 |
| 20.4 | 354 | 234 | 228 |
| 30.0 | 296 | 235 | 233 |
| 31.2 (Reference | 261 | 238 | 234 |
| example) | | | |
| 39.1 (Reference | 238 | 231 | 242 |
| example) | | | |

TABLE 2
Thickness of dielectric layer: 0.5 μm
Current (nA)

| | Five-face | L-shaped | U-shaped |
|---|---|---|---|
| Thickness of | electrodes | two-face | three-face |
| side margin | (Comparative | electrodes | electrodes |
| (μm) | example) | (Example) | (Example) |
| 9.7 | 2420 | 2047 | 2014 |
| 30.0 | 2159 | 2027 | 2030 |
| 30.9 (Reference | 2063 | 2022 | 2031 |
| example) | | | |

As revealed by Tables 1 and 2, the current of the five-face electrodes in the comparative example was slightly larger when the side margin was thicker than 30 μm; however, the multilayer ceramic capacitors in the examples and comparative example all had more or less equivalent current and generated no leak current.

On the other hand, the multilayer ceramic capacitor having five-face electrodes in the comparative example exhibited a tendency of rising current as the side margins became thinner (this explains leak current). Particularly when the thickness of side margin became 30 μm or less, the increase in leak current relative to the decrease in side margin thickness became pronounced. On the other hand, with the multilayer ceramic capacitors conforming to the present invention, having L-shaped or U-shaped electrodes with no external electrode formed on the side faces, the increase in current relative to the decrease in side margin thickness was less than what was observed with the five-face electrode type.

This means that, according to the present invention, the side margin thickness can be reduced to 30 μm or less and still leak current generating on the side faces on the basis of thinner side margins can be suppressed and the insulation resistance of the multilayer ceramic capacitor can be kept high as a result.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2015-069462, filed Mar. 30, 2015, No. 2015-250225, filed Dec. 22, 2015, and 2016-002749, filed Jan. 8, 2016, each disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A multilayer ceramic capacitor, having:
an element body which is constituted by dielectric layers stacked alternately with internal electrode layers having different polarities and whose shape is roughly a rectangular solid having a pair of principle faces, a pair of end faces, and a pair of side faces, wherein;
the pair of side faces of the element body has a pair of side margins whose thickness is 30 μm or less; and
external electrodes are formed on the pair of end faces, and at least one of the pair of principle faces, of the element body, wherein no external electrodes are formed in a region of the pair of side faces where the internal electrode layers having different polarities overlap as viewed in a thickness direction.

2. A multilayer ceramic capacitor according to claim 1, wherein a thickness of the pair of side margins is 1 μm or more.

3. A multilayer ceramic capacitor according to claim 1, wherein the external electrodes are formed on the pair of end faces and one principle face of the element body.

4. A multilayer ceramic capacitor according to claim 2, wherein the external electrodes are formed on the pair of end faces and one principle face of the element body.

5. A multilayer ceramic capacitor according to claim 1, wherein a thickness of the dielectric layer is 0.8 μm or less.

6. A multilayer ceramic capacitor according to claim 2, wherein a thickness of the dielectric layer is 0.8 μm or less.

7. A multilayer ceramic capacitor according to claim 3, wherein a thickness of the dielectric layer is 0.8 μm or less.

8. A multilayer ceramic capacitor according to claim 4, wherein a thickness of the dielectric layer is 0.8 μm or less.

9. A multilayer ceramic capacitor according to claim 1, wherein no external electrodes are formed in the entire side faces.
